(19) United States
(12) Patent Application Publication
(10) Pub. No.: US 2017/0126420 A1
(43) Pub. Date: May 4, 2017

(54) METHOD FOR CONTROLLING ELECTRONIC DEVICE

(71) Applicant: Xiaomi Inc., Beijing (CN)

(72) Inventors: Yanlu Zhang, Beijing (CN); Deguo Meng, Beijing (CN); Enxing Hou, Beijing (CN)

(21) Appl. No.: 15/137,000

(22) Filed: Apr. 25, 2016

(30) Foreign Application Priority Data
Oct. 29, 2015 (CN) 201510719315.6

(51) Int. Cl. H04L 12/28; H04L 12/26; G05B 19/042

(52) U.S. Cl. CPC H04L 12/283; G05B 19/042; H04L 43/50; G05B 2219/2642

(57) ABSTRACT

Described is a method for controlling an electronic device and the electronic device thereof. The method includes: receiving a signal from the control device, the signal carrying a control instruction for requesting the electronic device to perform a task; calculating a strength of the signal; determining whether the strength of the signal is higher than a preset strength value; retrieving the control instruction from the signal in response to determining that the strength of the signal is higher than the preset strength value; and performing the task according to the control instruction.

### CROSS-REFERENCE TO RELATED APPLICATIONS

This application is based upon and claims priority to Chinese Patent Application No. 201510719315.6, filed on Oct. 29, 2015, the entire contents of which are incorporated herein by reference.

### TECHNICAL FIELD

The present disclosure generally relates to the field of smart home, and more particularly, to a method for controlling an electronic device and the electronic device thereof.

### BACKGROUND

At present, most of electronic devices (such as smart home device) may be controlled by remote controllers. Moreover, in order to facilitate use by a user, multiple electronic devices in a same spatial environment may be controlled by one remote controller.

When one remote controller is used to control multiple electronic devices, in order to avoid influence of one electronic device on another electronic device, the remote controller needs to be bound with the first electronic device to control it at first. Then if a second electronic device is required to be controlled, it is necessary to unbind the currently bound first electronic device. In a related technology, a process of binding a remote controller with electronic device is relatively complex. A user is usually required to simultaneously operate the remote controller and the electronic device, and even with assistance of third-party device sometimes, so that an operating experience of the user is seriously influenced.

### SUMMARY

According to a first aspect of embodiments of the present disclosure, there is provided a control method for use in an electronic device connected with a control device. The method includes: receiving a signal from the control device, the signal carrying a control instruction for requesting the electronic device to perform a task; calculating a strength of the signal; determining whether the strength of the signal is higher than a preset strength value; retrieving the control instruction from the signal in response to determining that the strength of the signal is higher than the preset strength value; and performing the task according to the control instruction.

According to a second aspect of embodiments of the present disclosure, there is provided an electronic device connected with a control device. The the electronic device includes a processor and a memory for storing instructions executable by the processor, wherein the processor is configured to perform: receiving a signal from the control device, the signal carrying a control instruction for requesting the electronic device to perform a task; calculating a strength of the signal; determining whether the strength of the signal is higher than a preset strength value; retrieving the control instruction from the signal in response to determining that the strength of the signal is higher than the preset strength value; and performing the task according to the control instruction.

According to a third aspect of embodiments of the present disclosure, there is provided a non-transitory computer-readable storage medium having stored therein instructions that, when executed by an electronic device, causes the electronic device to perform a control method for use in the electronic device. The method includes: receiving a signal from the control device, the signal carrying a control instruction for requesting the electronic device to perform a task; calculating a strength of the signal; determining whether the strength of the signal is higher than a preset strength value; retrieving the control instruction from the signal in response to determining that the strength of the signal is higher than the preset strength value; and performing the task according to the control instruction.

It is to be understood that the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram illustrating an application scenario involved in a method for controlling an electronic device according to the present disclosure.

FIG. 2 is a flow chart showing a method for controlling an electronic device according to an exemplary embodiment.

FIG. 3A is a flow chart showing a method for controlling an electronic device according to another exemplary embodiment.

FIG. 3B is a flow chart showing a method for acquiring a control instruction according to an embodiment shown in FIG. 3A.

FIG. 3C is a flow chart showing another method for acquiring a control instruction according to an embodiment shown in FIG. 3A.

FIG. 3D is a flow chart showing yet another method for acquiring a control instruction according to an embodiment shown in FIG. 3A.

FIG. 4 is a flow chart showing a method for controlling an electronic device according to another exemplary embodiment.

FIG. 5 is a block diagram of an apparatus for controlling an electronic device according to an exemplary embodiment.

FIG. 6 is a block diagram of an apparatus for controlling an electronic device according to another exemplary embodiment.

FIG. 7 is a block diagram of an electronic device according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

FIG. 1 is a schematic diagram illustrating an application scenario involved in a method for controlling an electronic device according to the present disclosure. The devices involved in the application scenario may include: a control device 110 and an execution device 120.

The control device 110 may be a specialized device, such as a remote controller, for controlling another electronic device through a wireless signal. Alternatively, the control device 110 may also be a smart device with a control function, such as a smart phone, a tablet computer, an electronic book reader, smart wearable device (a smart watch and a smart band) or the like.

The execution device 120 may receive a control instruction sent by the control device through a wireless signal and perform corresponding task according to the control instruction.

In a possible scenario, the control device 110 may be a remote controller, and the execution device 120 may be various types of smart household appliances such as a smart television, a set-top box, an air conditioner and a purifier.

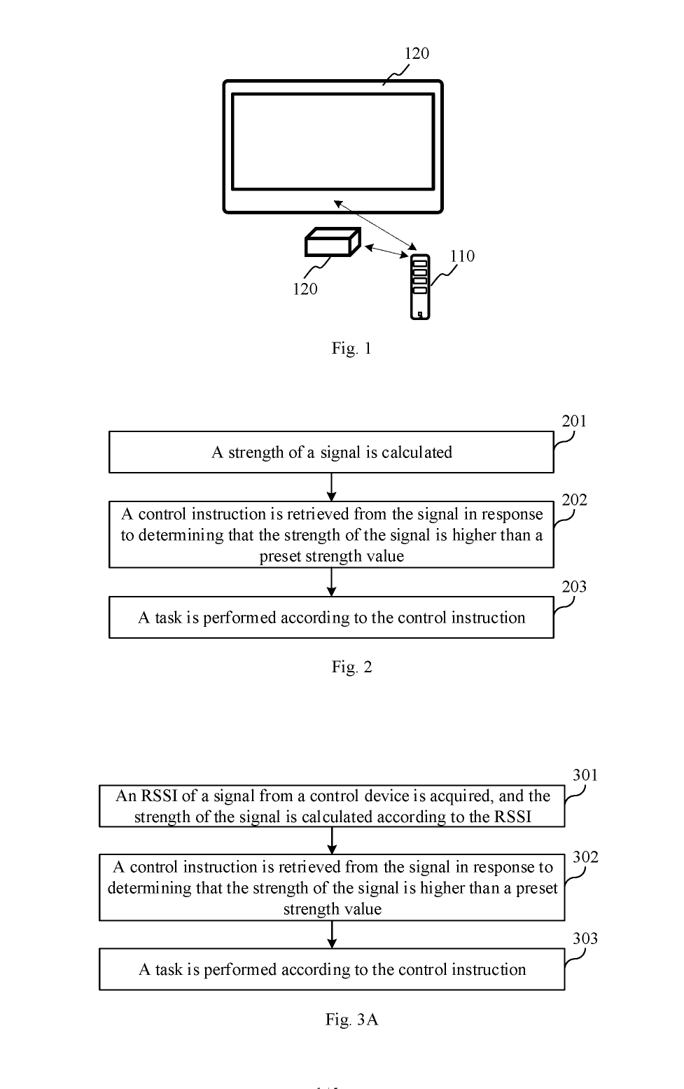

FIG. 2 is a flow chart showing a method for controlling an electronic device according to an exemplary embodiment. The method provided by the embodiment may be implemented by an execution device 120 in an application scenario shown in FIG. 1. In other words, the controlled electronic device is the execution device 120. The method may include the following steps.

In step 201, a strength of a signal from a control device is calculated. Prior to this step, the signal is received from the control device and the signal carries a control instruction for requesting the electronic device to perform a task.

In step 202, it is determined whether the strength of the signal is higher than a preset strength value and a control instruction is retrieved from the signal in response to determining that the strength of the signal is higher than a preset strength value.

In step 203, the task is performed according to the control instruction.

From the above, according to the method for controlling an electronic device provided by embodiments of the disclosure, the strength of the signal received from the control device is calculated, the control instruction is retrieved from the signal in response to determining that the strength of the signal is higher than the preset strength value and the task is performed according to the control instruction, and the strength of the signal received from the control device is determined as one of conditions of processing the control instruction sent by the control device. When the signal strength between the execution device and the control device is higher than a certain value (in other words, the execution device is close enough to the control device), the instruction received from the control device may be executed by the execution device. Therefore, a user may selectively control a certain execution device only by mastering a distance between the control device and the execution device, thereby simplifying user operations and improving user experiences.

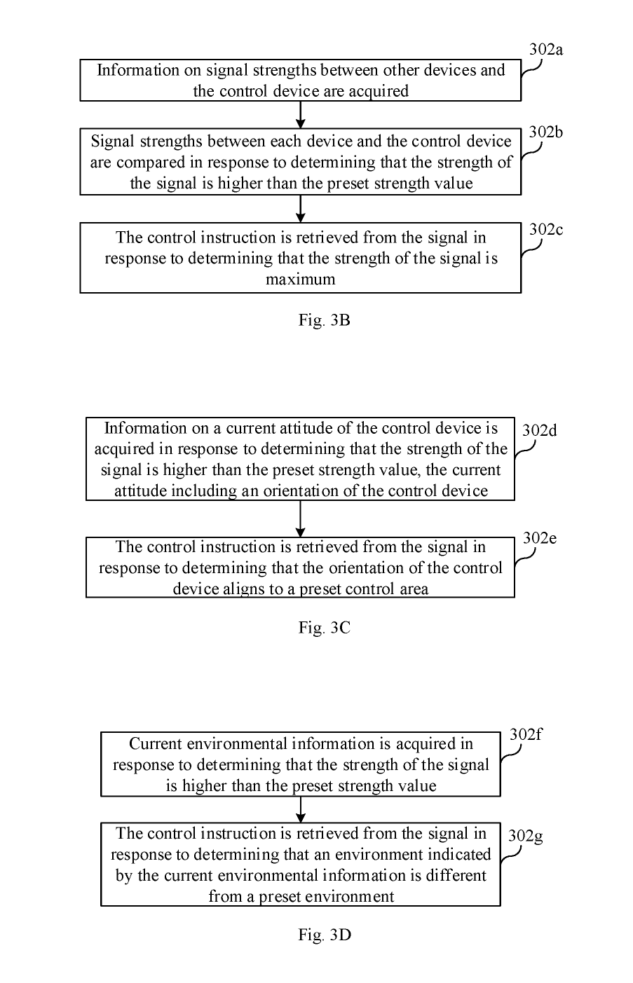

FIG. 3A is a flow chart showing a method for controlling an electronic device according to another exemplary embodiment. The method provided by the embodiment may be implemented by an execution device 120 in an application scenario shown in FIG. 1. In other words, the controlled electronic device is the execution device 120. The method for controlling an electronic device may include the following steps.

In step 301, a received signal strength indicator (RSSI) of a signal from a control device is acquired, and the strength of the signal is calculated according to the RSSI.

In the embodiment of the present disclosure, the signal strength between the execution device and the control device may be acquired through an RSSI value of a wireless signal sent by the control device.

Herein, the execution device may perform instruction interaction with the control device, and correspondingly, the signal strength is bluetooth (BT) signal strength. The control device establishes a BT connection with the execution device before sending a control instruction to the execution device through a BT signal.

Optionally, the execution device may interact with the control device through another type of wireless signal, such as a Wireless Local Area Network (WLAN) signal.

In step 302, a control instruction is retrieved from the signal in response to determining that the strength of the signal is higher than a preset strength value.

When signal transmission power of the control device is unchanged, signal strength of the wireless signal, received by the execution device, of the control device is higher if the control device is closer to the execution device. On the contrary, the signal strength of the wireless signal, received by the execution device, of the control device is lower. Only when the signal strength of the wireless signal sent from the control device and received by the execution device is high enough, that is, the control device is close enough to the execution device, the execution device may process the instruction sent by the control device. A user may move the control device to get close to the execution device and send the control instruction to control the execution device.

Optionally, in the embodiment of the present disclosure, in order to improve accuracy in user operation and avoid misoperation of the user, whether to trigger processing of the control instruction or not may also be determined in combination with other related conditions on the basis of the condition that the signal strength is higher than the preset signal strength value.

FIG. 3B is a flow chart showing a method for acquiring a control instruction according to an embodiment shown in FIG. 3A. In an implementation mode of the present disclosure, referring to FIG. 3B, the method may include Step 302a to Step 302c.

In step 302a, information on strengths of second signals communicated between other devices and the control device are acquired.

In step 302b, the strengths of the second signals and the the strength of the signal are compared in response to determining that the strength of the signal is higher than the preset strength value.

In step 302c, the control instruction is retrieved from the signal in response to determining that the strength of the signal is higher than the strengths of the second signals.

In the embodiment of the present disclosure, the control device may be simultaneously bound with multiple execution devices. When two execution devices are close and both may receive the wireless signal sent by the control device (for example, the wireless signal sent by the control device is a WLAN signal) and the signal strength of the received wireless signal is high enough, the two execution devices may respond to the control instruction in the wireless signal, and the user usually wants to control only one device, so that misoperation may be generated. In order to avoid the abovementioned situation, in the embodiment of the present disclosure, when the execution device receives the wireless signal sent from the control device, besides determining whether the signal strength of the wireless signal is high enough, the execution device may also acquire a signal strength of the signal sent from the control device and received by each of other devices, the signal strength being sent by each of the other devices which receives the signal sent from the control device, and determine whether the signal strength of the signal received by the execution device is higher than the signal strength of the signals received by all of the other device or not. If YES, it is indicated that the control device is closest to the execution device, and the execution device may acquire the control instruction in the wireless signal and perform subsequent processing.

FIG. 3C is a flow chart showing another method for acquiring a control instruction according to an embodiment shown in FIG. 3A. In another implementation mode of the present disclosure, referring to FIG. 3C, the method may include Step 302d and Step 302e.

In step 302d, information on a current attitude of the control device is acquired in response to determining that the strength of the signal is higher than the preset strength value, the current attitude including an orientation of the control device.

In step 302e, the control instruction is retrieved from the signal in response to determining that the orientation of the control device aligns to a preset control area.

In the embodiment of the present disclosure, the attitude of the control device, besides the signal strength, may also be combined as a basis of making a response to the control instruction sent by the control device. For example, an attitude sensor is arranged in the control device, the attitude of the control device is acquired in real time, and the control device also contain the current attitude in the wireless signal when sending the wireless signal including the control instruction. When the execution device determines that the signal strength of the wireless signal received from the control device is higher than the preset strength value and the orientation of the control device is determined to align to the preset control area on the execution device according to the attitude of the control device, it may be determined that destination device of the wireless signal sent by the control device is the execution device, and then the execution device may acquire the control instruction in the wireless signal and perform subsequent processing.

FIG. 3D is a flow chart showing another method for acquiring a control instruction according to an embodiment shown in FIG. 3A. In another implementation mode of the present disclosure, referring to FIG. 3D, the method may include Step 302f and Step 302g.

In step 302f, current environmental information is acquired in response to determining that the strength of the signal is higher than the preset strength value, the current environmental information indicating a surrounding environment of the electronic device.

In step 302g, the control instruction is retrieved from the signal in response to determining that an environment indicated by the current environmental information is different from a preset environment.

During a practical application, use of a part of execution device may be related to a climatic environment, and for example, an electric fan is usually used only in summer, an air conditioner is usually used only in summer and winter, and an electric heater and a bath heater are usually used only in winter. When the user operates the controlled device through the control device in seasons when the execution device is not used under a normal condition, it may probably be misoperation of the user. Therefore, in the embodiment of the present disclosure, when the execution device receives the wireless signal sent by the control device, the execution device is also required to detect whether the current environment (such as season) is the same as the preset environment (such as a season when the execution device is not used under the normal condition) or not, besides determining whether the signal strength of the wireless signal is high enough or not, and may acquire the control instruction in the wireless signal and perform subsequent processing if the current environment is different from the preset environment.

Optionally, when it is determined that the signal strength of the wireless signal is high enough and the current environment (such as season) is the same as the preset environment, the execution device may also give a prompt, such as an acoustic-optic prompt or a voice prompt, to prompt the user that the execution device is not required to be used for the environment where the user is currently located.

In another implementation mode of the present disclosure, the execution device may also acquire a time length for which the wireless signal is continuously received in response to determining that the signal strength is higher than the preset strength value and acquire the control instruction sent by the control device in response to the time length for which the wireless signal is continuously received.

In a practical application process, the user may mistakenly touch a certain control key in the control device, and then an event of mistakenly operating the execution device may occur if the control device is excessively close to the execution device. Since a process of mistakenly touching a certain control key by the user is usually short, a time limit may be set for validation of the control instruction to reduce a possibility of misoperation on the basis of determining that the signal strength is higher than the preset strength value in the embodiment of the present disclosure. Only when the control device is close enough to the execution device and the user presses the control key for a certain period of time at the same time, the execution device may acquire the control instruction sent by the control device.

Optionally, each response condition involved in the abovementioned implementation modes may be independently used, and part or all of the response conditions may be combined for use. For example, only when the signal strength of the wireless signal is higher than the preset strength value, the time length for which the wireless signal is continuously received exceeds a preset time length, the environment where the execution device is currently located is different from the preset environment and the signal strength of the wireless signal received by the execution device is a maximum value compared with the signal strength of the wireless signal received by each of the other devices, the execution device may acquire the control instruction sent by the control device.

In step 303, the task is performed according to the control instruction.

Optionally, in a probable implementation mode, performing according to the control instruction may be performing binding to the control device or unbinding from the control device according to the control instruction. By the above mentioned method, the user may implement a step of binding and unbinding the device only by moving the control device close to the execution device and pressing down a specific key when the execution device is bound or unbound with the control device, so that the operation step of binding or unbinding the device is simplified.

Optionally, the method of the embodiment of the present disclosure may not be limited to the function of binding and unbinding, and may also be configured for ordinary control over device to be controlled, such as startup, shutdown and other control.

The application scenario that the control device is a remote controller and the execution device is a set-top box is taken as an example. The user may establish a BT connection between the remote controller and the set-top box at first, move the remote controller close to the set-top box and press down a binding/unbinding key when wanting to bind/unbind the remote controller and the set-top box. Then the remote controller sends a BT signal including a binding/unbinding instruction to the set-top box. Further, the set-top box receives the BT signal sent by the remote controller, determines that an RSSI value of the BT signal is higher than a preset threshold value, and bind itself to the remote controller. Moreover, the set-top box may directly execute corresponding task when subsequently receiving a wireless signal containing a non-unbinding instruction from the remote controller. Optionally, for avoiding misoperation, the set-top box of the user may also detect a duration in which the BT signal including the binding signal is continuously received, and bind itself to the remote controller when the duration in which the BT signal is continuously received exceeds 2S.

In addition, in the abovementioned example, the remote controller may also be connected with multiple controllable devices including the set-top box in a WLAN manner. For example, the remote controller may simultaneously establish WLAN connections with the set-top box and a smart television, a WLAN signal sent by the remote controller may be simultaneously received by the set-top box and the smart television, the set-top box is closer to the smart television under a normal condition, an RSSI value of the WLAN signal, received by the smart television, of the remote controller may also be higher than the preset threshold value when the user moves the remote controller close to the set-top box, and then, if the user wants to bind/unbind the set-top box and the remote controller, the smart television may also be bound with the remote controller when the remote controller sends the WLAN signal including a binding/unbinding instruction. In order to avoid such a condition, the set-top box and the smart television may send the RSSI values of own received WLAN signals, the set-top box determines that the RSSI value of the WLAN signal received by the set-top box is higher than the RSSI value of the WLAN signal received by the smart television, and is bound with the remote controller, and the smart television determines that the RSSI value of the WLAN signal received by the smart television is lower than the RSSI value of the WLAN signal received by the set-top box, and does not perform binding operation.

The embodiment that the control device is the remote controller and the execution device is the set-top box is taken as an example again. During another practical application, an attitude sensor is also arranged in the remote controller, and is configured to detect the attitude of the remote controller in real time. When a binding/unbinding command is sent to the set-top box through a wireless signal such as a BT signal or a WLAN signal, real-time attitude information is contained in the wireless signal. After receiving the wireless signal and confirming that the strength of the wireless signal is higher than the preset strength value, the set-top box may also determine whether an orientation of the remote controller aligns to a preset control area or not according to a receiving angle of the wireless signal and a current attitude of the remote controller. If YES, binding/unbinding operation is performed. That is, the user is also required to enable the remote controller to point to the preset control area, besides moving the remote controller close to the set-top box, when wanting to control the set-top box.

During another practical application, the remote controller establishes a WLAN connection with the set-top box, the control device is the remote controller, and the execution device is a smart air conditioner. The user establishes a wireless (BT or WLAN) connection between the remote controller and the set-top box at first, moves the remote controller close to the smart air conditioner and presses down the binding/unbinding key when wanting to bind/unbind the remote controller and the set-top box, then the remote controller sends a wireless signal including a binding/unbinding instruction to the smart air conditioner, and the smart air conditioner further determines whether a current season is a season (spring or autumn) when the smart air conditioner is not used or not after receiving the signal sent by the remote controller and determining that an RSSI value of the signal is higher than a preset threshold value, is bound with the remote controller if the current season is spring or autumn, and if the current season is not spring or autumn, is temporarily not bound with the remote controller and simultaneously prompts the user that the current season is not the season when the smart air conditioner is used and whether to confirm binding/unbinding or not, and is bound with the remote controller if the user presses down the binding/unbinding key in the remote controller again.

From the above, according to the method for controlling an electronic device provided by embodiments of the disclosure, the strength of the signal from the control device is calculated, the control instruction is retrieved from the signal in response to determining that the strength of the signal is higher than the preset strength value and the task is performed according to the control instruction, and the strength of the signal from the control device is determined as one of conditions of processing the control instruction sent by the control device. When the signal strength between the execution device and the control device is higher than a certain value, that is, the execution device is close enough to the control device, the instruction of the control device may be executed. Therefore, a user may selectively control a certain execution device only by mastering a distance between the control device and the execution device, thereby simplifying user operations and improving user experiences.

In addition, according to the method provided by the embodiment of the present disclosure, whether to process the control instruction or not may also be determined in combination with the other conditions, such as whether the time length for which the wireless signal is continuously received exceeds the preset time length or not, whether the signal strength of the wireless signal received by the execution device is the maximum value in the signal strength of the wireless signal received by each device or not, whether the orientation of the control device aligns to the preset control area or not and whether the environment where the execution device is currently located is matched with a service environment of the execution device or not, so that the possibility of misoperation of the user is reduced, and control performance is improved.

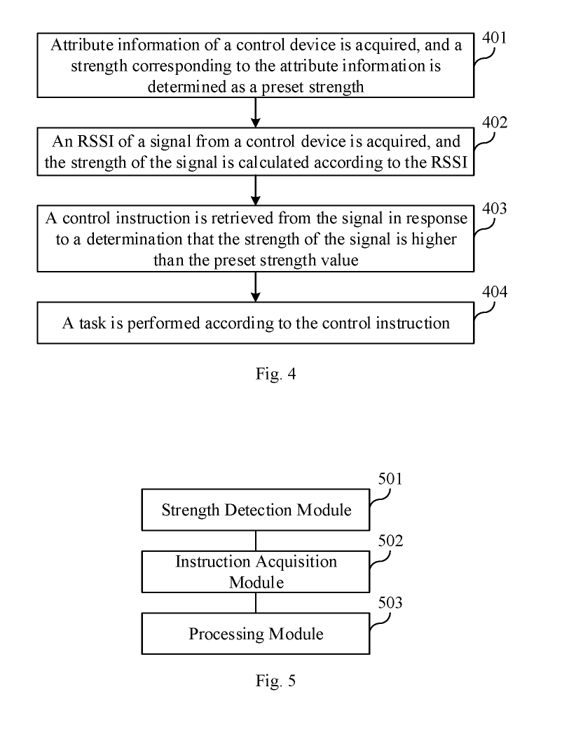

FIG. 4 is a flow chart showing a method for controlling an electronic device according to another exemplary embodiment. The method provided by the embodiment of the present disclosure may be implemented by execution device 120 in an application scenario shown in FIG. 1. The method for controlling an electronic device may include the following steps.

In step 401, attribute information of a control device is acquired, and a strength corresponding to the attribute information is determined as a preset strength value.

The attribute information includes at least one of the following two: a device identifier and transmission power, the transmission power being positively correlated with the preset strength value.

Herein, the attribute information of the control device may be contained in a wireless signal including a control instruction, and may also be independently sent to the execution device distinctively from the control instruction.

Different control device may have different wireless signal transmission power, and a user may have multiple control devices. If the execution device determines whether to acquire the control instruction or not by virtue of the same preset strength value, when the signal transmission power of a certain control device is lower, the user is required to move the control device closer to the execution device. On the contrary, when the signal transmission power of a certain control device is higher, the user may operate at a longer distance. In order to unify control distances of different control device, the execution device may determine the preset strength value according to the attribute information of the control device in the wireless signal, for example, the device identifier or transmission power of the control device. For example, the execution device may query the wireless signal transmission power of the control device according to the device identifier of the control device and determine the preset strength value according to the transmission power. Alternatively, the execution device may also directly read the transmission power in the wireless signal and determine the preset strength value according to the transmission power.

For example, the execution device is a set-top box and the control device is a remote controller, and an expected distance between the set-top box and the remote controller is 5 cm when the set-top box accepts binding/unbinding operation of the remote controller. Strength corresponding to different transmission power may be preset in the set-top box, and for example, the strength corresponding to the transmission power may be signal strength of the wireless signal sent with the transmission power at a position which is 5 cm far away from a signal source. It can be understood that attenuation curves of signal strength of two wireless signals with the same or similar frequencies are also similar when transmission distances are the same, that is, signal strength of a signal sent with higher transmission power is higher after being transmitted by the same distance. The set-top box may extract the transmission power of the wireless signal in the wireless signal when receiving the wireless signal sent by the remote controller, and query the pre-stored strength corresponding to the transmission power and determine the queried strength as the preset strength value. Optionally, the set-top box may also not store the strength corresponding to different transmission power, and calculates the preset strength value according to the transmission power and the expected distance after acquiring the transmission power of the wireless signal.

In step 402, an RSSI of a signal from a control device is acquired, and the strength of the signal is acquired according to the RSSI.

In step 403, a control instruction is retrieved from the signal in response to determining that the strength of the signal is higher than the preset strength value.

In step 404, the task is performed according to the control instruction.

An implementation process from Step 402 to Step 404 may refer to description about Step 301 to Step 303 in the embodiment corresponding to FIG. 3A, and will not be repeated here.

From the above, according to the method for controlling an electronic device provided by embodiments of the disclosure, the strength of the signal from the control device is calculated, the control instruction is retrieved from the signal in response to determining that the strength of the signal is higher than the preset strength value and the task is performed according to the control instruction, and the strength of the signal from the control device is determined as one of conditions of processing the control instruction sent by the control device. When the signal strength between the execution device and the control device is higher than a certain value, that is, the execution device is close enough to the control device, the instruction of the control device may be executed. Therefore, a user may selectively control a certain execution device only by mastering a distance between the control device and the execution device, thereby simplifying user operations and improving user experiences.

In addition, according to the method provided by the embodiment of the present disclosure, whether to process the control instruction or not may also be determined in combination with the other conditions, such as whether a time length for which the wireless signal is continuously received exceeds a preset time length or not, whether the signal strength of the wireless signal received by the execution device is the maximum value in the signal strength of the wireless signal received by each device or not, whether an orientation of the control device aligns to a preset control area or not and whether an environment where the execution device is currently located is matched with a service environment of the execution device or not, so that a possibility of misoperation of the user is reduced, and control performance is improved.

In addition, according to the method provided by the embodiment of the present disclosure, the preset strength value is determined according to the device identifier or transmission power of the control device, and the control distances of different control device are unified, so that an operation experience of the user is further improved.

Apparatus embodiments of the present disclosure are described below, and may be configured to execute the method embodiments of the present disclosure. Details undisclosed in the apparatus embodiments of the present disclosure refer to the method embodiments of the present disclosure.

FIG. 5 is a block diagram of an apparatus for controlling an electronic device according to an exemplary embodiment. The apparatus for controlling an electronic device may be implemented into a part or all of the execution device 120 in the application scenario shown in FIG. 1 by virtue of software, hardware or a combination of the two, and is configured to execute the method for controlling an electronic device shown in any one of FIG. 2, FIG. 3A and FIG. 4. The apparatus for controlling an electronic device may include: a strength detection module 501, an instruction acquisition module 502 and a processing module 503. Herein, the strength detection module 501 is configured to calculate signal strength between execution device and control device; the instruction acquisition module 502 is configured to acquire a control instruction sent by the control device in response to determination that the signal strength calculated by the strength detection module 501 is higher than preset strength value; and the processing module 503 is configured to perform the task according to the control instruction acquired by the instruction acquisition module 502.

From the above, according to the apparatus for controlling an electronic device provided by embodiments of the disclosure, the strength of the signal from the control device is calculated, the control instruction is retrieved from the signal in response to determining that the strength of the signal is higher than the preset strength value and the task is performed according to the control instruction, and the strength of the signal from the control device is determined as one of conditions of processing the control instruction sent by the control device. When the signal strength between the execution device and the control device is higher than a certain value, that is, the execution device is close enough to the control device, the instruction of the control device may be executed. Therefore, a user may selectively control a certain execution device only by mastering a distance between the control device and the execution device, thereby simplifying user operations and improving user experiences.

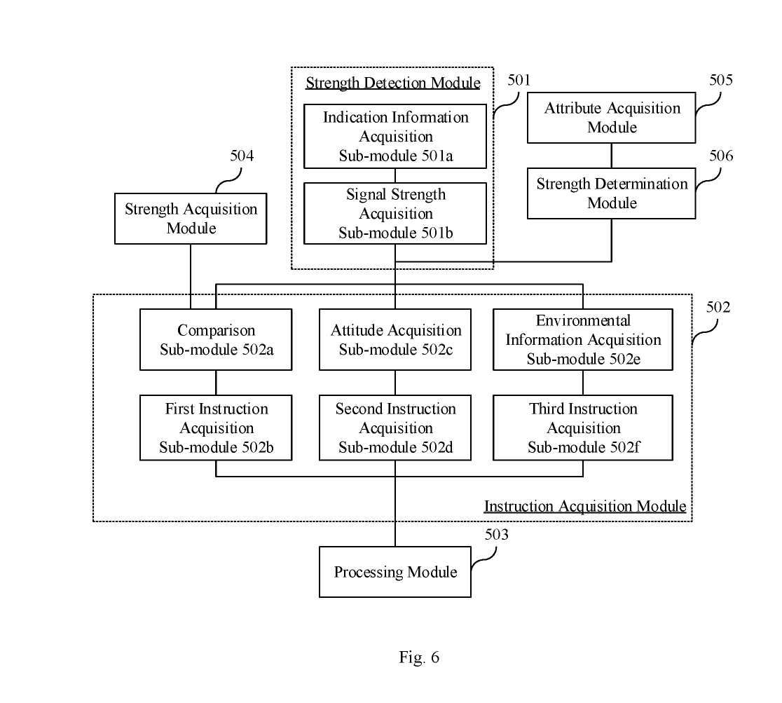

FIG. 6 is a block diagram of an apparatus for controlling an electronic device according to another exemplary embodiment. The apparatus for controlling an electronic device may be implemented into a part or all of the execution device 120 in the application scenario shown in FIG. 1 by virtue of software, hardware or a combination of the two, and is configured to execute the method for controlling an electronic device shown in any one of FIG. 2, FIG. 3A and FIG. 4. The apparatus for controlling an electronic device may include: a strength detection module 501, an instruction acquisition module 502 and a processing module 503. Herein, the strength detection module 501 is configured to calculate signal strength between execution device and control device; the instruction acquisition module 502 is configured to acquire a control instruction sent by the control device in response to determination that the signal strength calculated by the strength detection module 501 is higher than preset strength value; and the processing module 503 is configured to perform the task according to the control instruction acquired by the instruction acquisition module 502.

Optionally, the apparatus for controlling an electronic device further includes: a strength acquisition module 504.

The strength acquisition module 504 is configured to acquire information on strengths of second signals, the second signals being communicated between other devices and the control device.

The instruction acquisition module 502 includes: a comparison sub-module 502a and a first instruction acquisition sub-module 502b.

The comparison sub-module 502a is configured to compare the strengths of the second signals with the the strength of the signal in response to determining that the signal strength calculated by the strength detection module 501 is higher than the preset strength value.

The first instruction acquisition sub-module 502b is configured to acquire the control instruction sent by the control device in response to determination that the signal strength between the execution device and the control device is maximum.

Optionally, the instruction acquisition module 502 includes: an attitude acquisition sub-module 502c and a second instruction acquisition sub-module 502d.

The attitude acquisition sub-module 502c is configured to acquire a current attitude of the control device in response to determining that the signal strength calculated by the strength detection module 501 is higher than the preset strength value, the current attitude including an orientation of the control device.

The second instruction acquisition sub-module 502d is configured to acquire the control instruction sent by the control device in response to determination that the orientation of the control device aligns to a preset control area.

Optionally, the instruction acquisition module 502 includes: an environmental information acquisition sub-module 502e and a third instruction acquisition sub-module 502f.

The environmental information acquisition sub-module 502e is configured to acquire current environmental information in response to determining that the signal strength calculated by the strength detection module 501 is higher than the preset strength value.

The third instruction acquisition sub-module 502f is configured to acquire the control instruction sent by the control device in response to determination that an environment indicated by the environmental information acquired by the environmental information acquisition sub-module 502e is different from a preset environment.

Optionally, the processing module 503 is configured to perform binding to the control device or unbinding from the control device according to the control instruction.

Optionally, the apparatus further includes: an attribute acquisition module 505 and a strength determination module 506.

The attribute acquisition module 505 is configured to acquire attribute information of the control device.

The strength determination module 506 is configured to determine strength corresponding to the attribute information acquired by the attribute acquisition module 505 as the preset strength value.

The attribute information includes at least one of the following two: a device identifier and transmission power, the transmission power being positively correlated with the preset strength value.

Optionally, the strength detection module 501 includes: an indication information acquisition sub-module 501a and a signal strength acquisition sub-module 501b.

The indication information acquisition sub-module 501a is configured to acquire an RSSI between the execution device and the control device.

The signal strength acquisition sub-module 501b is configured to acquire the signal strength according to the RSSI acquired by the indication information acquisition sub-module.

Optionally, the signal strength may include: BT signal strength.

From the above, according to the apparatus for controlling an electronic device provided by the embodiment of the present disclosure, the strength of the signal from the control device is calculated, the control instruction is retrieved from the signal in response to determining that the strength of the signal is higher than the preset strength value and the task is performed according to the control instruction, and the strength of the signal from the control device is determined as one of conditions of processing the control instruction sent by the control device. When the signal strength between the execution device and the control device is higher than a certain value, that is, the execution device is close enough to the control device, the instruction of the control device may be executed. Therefore, a user may selectively control a certain execution device only by mastering a distance between the control device and the execution device, thereby simplifying user operations and improving user experiences.

In addition, according to the apparatus provided by the embodiment of the present disclosure, whether to process the control instruction or not may also be determined in combination with other conditions, such as whether a time length for which a wireless signal is continuously received exceeds a preset time length or not, whether signal strength of the wireless signal received by the execution device is a maximum value in the signal strength of the wireless signal received by each device or not, whether the orientation of the control device aligns to the preset control area or not and whether the environment where the execution device is currently located is matched with a service environment of the execution device or not, so that a possibility of misoperation of the user is reduced, and control performance is improved.

In addition, according to the apparatus provided by the embodiment of the present disclosure, the preset strength value is determined according to the device identifier or transmission power of the control device, and control distances of different control device are unified, so that the operation experience of the user is further improved.

It is to be noted that description is made only with division of each abovementioned functional module as an example when the apparatus provided by the embodiment controls electronic device, and during a practical application, the abovementioned functions may be allocated to different functional modules for realization according to a practical requirement, that is, a content structure of the device is divided into different functional modules to realize a part or all of the abovementioned functions.

With respect to the apparatuses in the above embodiments, the specific manners for performing operations for individual modules therein have been described in detail in the embodiments regarding the related methods, which will not be elaborated herein.

An exemplary embodiment of the present disclosure further provides an apparatus for controlling an electronic device, which may implement the above methods for controlling an electronic device provided by the present disclosure.

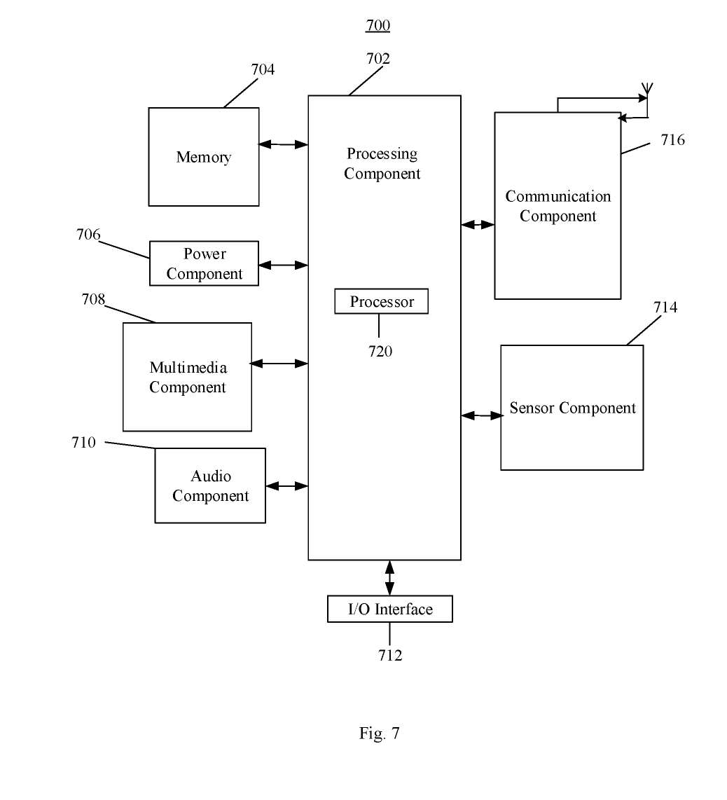

FIG. 7 is a block diagram of an electronic device 700 configured to control electronic device according to an exemplary embodiment. For example, the electronic device 700 may be a mobile phone, a computer, a digital broadcast terminal, a messaging apparatus, a gaming console, a tablet, a medical apparatus, exercise device, a personal digital assistant, smart home device and the like.

Referring to FIG. 7, the electronic device 700 may include one or more of the following components: a processing component 702, a memory 704, a power component 706, a multimedia component 708, an audio component 710, an Input/Output (I/O) interface 712, a sensor component 714, and a communication component 716.

The processing component 702 typically controls overall operations of the electronic device 700, such as the operations associated with display, telephone calls, data communications, camera operations, and recording operations. The processing component 702 may include one or more processors 720 to execute instructions to perform all or part of the steps in the abovementioned methods. Moreover, the processing component 702 may include one or more modules which facilitate interaction between the processing component 702 and the other components. For instance, the processing component 702 may include a multimedia module to facilitate interaction between the multimedia component 708 and the processing component 702.

The memory 704 is configured to store various types of data to support the operation of the electronic device 700. Examples of such data include instructions for any applications or methods operated on the electronic device 700, contact data, phonebook data, messages, pictures, video, etc. The memory 704 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 706 provides power for various components of the electronic device 700. The power component 706 may include a power management system, one or more power supplies, and other components associated with the generation, management and distribution of power for the electronic device 700.

The multimedia component 708 includes a screen providing an output interface between the electronic device 700 and a user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action, but also sense a duration and pressure associated with the touch or swipe action. In some embodiments, the multimedia component 708 includes a front camera and/or a rear camera. The front camera and/or the rear camera may receive external multimedia data when the electronic device 700 is in an operation mode, such as a photographing mode or a video mode. Each of the front camera and the rear camera may be a fixed optical lens system or have focusing and optical zooming capabilities.

The audio component 710 is configured to output and/or input an audio signal. For example, the audio component 710 includes a microphone (MIC), and the MIC is configured to receive an external audio signal when the electronic device 700 is in the operation mode, such as a call mode, a recording mode and a voice recognition mode. The received audio signal may be further stored in the memory 704 or sent through the communication component 716. In some embodiments, the audio component 710 further includes a speaker configured to output the audio signal.

The I/O interface 712 provides an interface between the processing component 702 and a peripheral interface module, and the peripheral interface module may be a keyboard, a click wheel, a button and the like. The button may include, but not limited to: a home button, a volume button, a starting button and a locking button.

The sensor component 714 includes one or more sensors configured to provide status assessment in various aspects for the electronic device 700. For instance, the sensor component 714 may detect an on/off status of the electronic device 700 and relative positioning of components, such as a display and small keyboard of the electronic device 700, and the sensor component 714 may further detect a change in a position of the electronic device 700 or a component of the electronic device 700, presence or absence of contact between the user and the electronic device 700, orientation or acceleration/deceleration of the electronic device 700 and a change in temperature of the electronic device 700. The sensor component 714 may include a proximity sensor configured to detect presence of an object nearby without any physical contact. The sensor component 714 may also include a light sensor, such as a Complementary Metal Oxide Semiconductor (CMOS) or Charge Coupled Apparatus (CCD) image sensor, configured for use in an imaging application. In some embodiments, the sensor component 714 may also include an acceleration sensor, a gyroscope sensor, a magnetic sensor, a pressure sensor or a temperature sensor.

The communication component 716 is configured to facilitate wired or wireless communication between the electronic device 700 and another apparatus. The electronic device 700 may access a communication-standard-based wireless network, such as a Wireless Fidelity (WiFi) network, a 2nd-Generation (2G) or 3rd-Generation (3G) network or a combination thereof. In an exemplary embodiment, the communication component 716 receives a broadcast signal or broadcast associated information from an external broadcast management system through a broadcast channel. In an exemplary embodiment, the communication component 716 further includes a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BT technology and another technology.

In the exemplary embodiment, the electronic device 700 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned methods.

In the exemplary embodiment, there is also provided a non-transitory computer-readable storage medium including an instruction, such as the memory 704 including an instruction, and the instruction may be executed by the processor 720 of the electronic device 700 to implement the abovementioned methods. For example, the non-transitory computer-readable storage medium may be a ROM, a Radom Access Memory (RAM), a Compact Disc Read-Only Memory (CD-ROM), a magnetic tape, a floppy disc, an optical data storage apparatus and the like.

According to the non-transitory computer-readable storage medium, when the instruction in the storage medium is executed by the processor of the electronic device 700, the electronic device 700 may execute the method for controlling an electronic device shown in any one of FIG. 2, FIG. 3A and FIG. 4.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

What is claimed is:

1. A control method for use in an electronic device, the electronic device being connected with a control device, the method comprising:
receiving a signal from the control device, the signal carrying a control instruction for requesting the electronic device to perform a task;
calculating a strength of the signal;
determining whether the strength of the signal is higher than a preset strength value;
retrieving the control instruction from the signal in response to determining that the strength of the signal is higher than the preset strength value; and
performing the task according to the control instruction.

2. The method according to claim 1, further comprising:
acquiring information on strengths of second signals, the second signals being communicated between other devices and the control device;
wherein retrieving the control instruction from the signal in response to determining that the strength of the signal is higher than the preset strength value comprises:
comparing the strengths of the second signals with the the strength of the signal, in response to determining that the strength of the signal is higher than the preset strength value; and
retrieving the control instruction from the signal in response to determining that the strength of the signal is higher than the strengths of the second signals.

3. The method according to claim 1, wherein retrieving the control instruction from the signal in response to determining that the strength of the signal is higher than the preset strength value comprises:
acquiring information on a current attitude of the control device in response to determining that the strength of the signal is higher than the preset strength value, the current attitude comprising an orientation of the control device; and
retrieving the control instruction from the signal in response to determining that the orientation of the control device aligns to a preset control area on the electronic device.

4. The method according to claim 1, wherein retrieving the control instruction from the signal in response to determining that the strength of the signal is higher than the preset strength value comprises:
acquiring current environmental information in response to determining that the strength of the signal is higher than the preset strength value, the current environmental information indicating a surrounding environment of the electronic device; and
retrieving the control instruction from the signal in response to determining that an environment indicated by the current environmental information is different from a preset environment.

5. The method according to claim 1, wherein performing the task according to the control instruction comprises:
binding the electronic device to the control device or unbinding the electronic device from the control device according to the control instruction.

6. The method according to claim 1, before determining whether the strength of the signal is higher than the preset strength value, further comprising:
acquiring attribute information of the control device; and
determining a strength corresponding to the attribute information as the preset strength value,
wherein the attribute information comprises at least one of a device identifier and transmission power, the transmission power being positively correlated with the preset strength value.

7. The method according to claim 1, wherein calculating the strength of the signal comprises:
acquiring a Received Signal Strength Indication (RSSI) of the signal; and
calculating the strength of the signal according to the RSSI.

8. The method according to claim 1, wherein the signal is a Bluetooth signal.

9. An electronic device, the electronic device being connected with a control device, the the electronic device comprising:
a processor; and
a memory for storing instructions executable by the processor,
wherein the processor is configured to perform:
receiving a signal from the control device, the signal carrying a control instruction for requesting the electronic device to perform a task;
calculating a strength of the signal;
determining whether the strength of the signal is higher than a preset strength value;
retrieving the control instruction from the signal in response to determining that the strength of the signal is higher than the preset strength value; and
performing the task according to the control instruction.

10. The electronic device according to claim 9, wherein the processor is further configured to perform:
acquiring information on strengths of second signals, the second signals being communicated between other devices and the control device;
wherein retrieving the control instruction from the signal in response to determining that the strength of the signal is higher than the preset strength value comprises:
comparing the strengths of the second signals with the the strength of the signal, in response to determining that the strength of the signal is higher than the preset strength value; and
retrieving the control instruction from the signal in response to determining that the strength of the signal is higher than the strengths of the second signals.

11. The electronic device according to claim 9, wherein retrieving the control instruction from the signal in response to determining that the strength of the signal is higher than the preset strength value comprises:
acquiring information on a current attitude of the control device in response to determining that the strength of the signal is higher than the preset strength value, the current attitude comprising an orientation of the control device; and
retrieving the control instruction from the signal in response to determining that the orientation of the control device aligns to a preset control area on the electronic device.

12. The electronic device according to claim 9, wherein retrieving the control instruction from the signal in response to determining that the strength of the signal is higher than the preset strength value comprises:
acquiring current environmental information in response to determining that the strength of the signal is higher than the preset strength value, the current environmental information indicating a surrounding environment of the electronic device; and
retrieving the control instruction from the signal in response to determining that an environment indicated by the current environmental information is different from a preset environment.

13. The electronic device according to claim 9, wherein performing the task according to the control instruction comprises:
binding the electronic device to the control device or unbinding the electronic device from the control device according to the control instruction.

14. The electronic device according to claim 9, wherein the processor is further configured to perform the following steps before determine whether the strength of the signal is higher than the preset strength value:
acquiring attribute information of the control device; and
determining a strength corresponding to the attribute information as the preset strength value,
wherein the attribute information comprises at least one of a device identifier and transmission power, the transmission power being positively correlated with the preset strength value.

15. The electronic device according to claim 9, wherein calculating the strength of the signal comprises:
acquiring a Received Signal Strength Indication (RSSI) of the signal; and
calculating the strength of the signal according to the RSSI.

16. The electronic device according to claim 9, wherein the signal is a Bluetooth signal.

17. A non-transitory computer-readable storage medium having stored therein instructions that, when executed by an electronic device, causes the electronic device to perform a control method for use in the electronic device, the method comprising:
receiving a signal from the control device, the signal carrying a control instruction for requesting the electronic device to perform a task;
calculating a strength of the signal;
determining whether the strength of the signal is higher than a preset strength value;
retrieving the control instruction from the signal in response to determining that the strength of the signal is higher than the preset strength value; and
performing the task according to the control instruction.
